(19) United States
(12) Patent Application Publication
(10) Pub. No.: US 2017/0093212 A1
(43) Pub. Date: Mar. 30, 2017

(54) POWER TRANSMITTING APPARATUS, METHOD OF CONTROLLING THE SAME, CONTROL APPARATUS, AND COMPUTER-READABLE STORAGE MEDIUM

(71) Applicant: CANON KABUSHIKI KAISHA, Tokyo (JP)

(72) Inventor: Kazuhide NAGAMINE, Kawasaki-shi (JP)

(21) Appl. No.: 15/264,127

(22) Filed: Sep. 13, 2016

(30) Foreign Application Priority Data
Sep. 28, 2015 (JP) 2015-190339

(51) Int. Cl. H02J 50/10; H02J 7/02; H02J 50/60

(52) U.S. Cl. CPC H02J 50/10; H02J 50/60; H02J 7/025

(57) ABSTRACT

A power transmitting apparatus performs wireless power transfer to a power receiving apparatus. The apparatus includes a power transmitting unit adapted to wirelessly transmit power; a first detection unit adapted to detect a foreign substance as an object different from a power receiving apparatus in a power transmission range of a power transmitting unit; a second detection unit adapted to detect a power receiving apparatus in the power transmission range; and a control unit adapted to output a predetermined notification concerning an error when the first detection unit detects the foreign substance and the second detection unit detects a power receiving apparatus and to limit output of the predetermined notification when the first detection unit detects the foreign substance and the second detection unit does not detect a power receiving apparatus.

### BACKGROUND OF THE INVENTION

Field of the Invention

The present invention relates to a power transmitting apparatus, a method of controlling the same, a control apparatus, and a computer-readable storage medium and, more particularly, to a wireless power transfer technique.

Description of the Related Art

Japanese Patent Laid-Open No. 2014-230299 discloses a power transmitting apparatus which wirelessly transmits power to a power receiving apparatus, in which when a foreign substance such as a metal different from that used for the power receiving apparatus is detected, the user is notified of the presence of the foreign substance by sound, light emission, or the like.

According to the above conventional arrangement, whenever detecting a foreign substance, the power transmitting apparatus notifies the user of the detection of the foreign substance, regardless of whether the power receiving apparatus is placed on the power transmitting apparatus. For this reason, even if the user has no intention to use the power transmitting apparatus, the apparatus notifies him/her of the detection of a foreign substance when he/she only brings something other than the power receiving apparatus close to the power transmitting apparatus. This is cumbersome for the user.

Assume that a power transmitting apparatus is mounted in a piece of furniture such as a table or in a vehicle. In this state, the user sometimes places something other than a power receiving apparatus such as a smartphone, for example, a key, near the power transmitting apparatus mounted in the furniture or vehicle. In this case, every time the user places a foreign substance, the apparatus notifies the user of the detection of the foreign substance. This is cumbersome for the user.

### SUMMARY OF THE INVENTION

The present invention provides a technique of reducing unnecessary notification concerning foreign substance detection when something other than a power receiving apparatus exists in the power transmission range of a power transmitting apparatus.

According to one aspect of the present invention, a power transmitting apparatus which performs wireless power transfer to a power receiving apparatus, the apparatus includes: a power transmitting unit adapted to wirelessly transmit power; a first detection unit adapted to detect a foreign substance as an object different from a power receiving apparatus in a power transmission range of a power transmitting unit; a second detection unit adapted to detect a power receiving apparatus in the power transmission range; and a control unit adapted to output a predetermined notification concerning an error when the first detection unit detects the foreign substance and the second detection unit detects a power receiving apparatus and to limit output of the predetermined notification when the first detection unit detects the foreign substance and the second detection unit does not detect a power receiving apparatus.

According to another aspect of the present invention, a control apparatus for a power transmitting apparatus including a power transmitting unit adapted to wirelessly transmit power, a first detection unit adapted to detect a foreign substance as an object different from a power receiving apparatus in a power transmission range of the power transmitting unit, and a second detection unit adapted to detect a power receiving apparatus in the power transmission range, the apparatus includes: a control unit adapted to perform a predetermined notification, when the first detection unit detects the foreign substance and the second detection unit detects a power receiving apparatus, and not to perform the predetermined notification when the first detection unit detects the foreign substance and the second detection unit does not detect a power receiving apparatus.

Further features of the present invention will become apparent from the following description of exemplary embodiments (with reference to the attached drawings).

### BRIEF DESCRIPTION OF THE DRAWINGS

FIG. 1 is a perspective view showing the arrangement of a power transmitting system;

FIG. 2 is a block diagram showing the arrangement of a power transmitting apparatus;

FIG. 3 is a block diagram showing the arrangement of a power receiving apparatus;

FIG. 4 is a flowchart showing an operation procedure of the power transmitting system;

FIG. 5 is a timing chart showing the operation timing of the power transmitting system;

FIGS. 6A, 6B, 6C, and 6D are perspective views each schematically showing a state around the power transmitting apparatus;

FIG. 7 is a flowchart showing an operation procedure of the power transmitting system;

FIG. 8 is a block diagram showing the arrangement of the power transmitting apparatus;

FIG. 9 is a flowchart showing an operation procedure of the power transmitting system;

FIGS. 10A and 10B are block diagrams each showing the arrangement of the power transmitting apparatus;

FIG. 11 is a perspective view schematically showing a state around the power transmitting apparatus;

FIG. 12 is a block diagram showing the arrangement of the power transmitting apparatus;

FIGS. 13A, 13B, and 13C are perspective views each showing a state around the power transmitting apparatus;

FIG. 14 is a flowchart showing an operation procedure of the power transmitting system;

FIG. 15 is a timing chart showing the operation timing of the power transmitting system; and

FIGS. 16A and 16B are perspective views each schematically showing a state around the power transmitting apparatus.

### DESCRIPTION OF THE EMBODIMENTS

An embodiment will be described in detail below with reference to the accompanying drawings.

(System Arrangement)

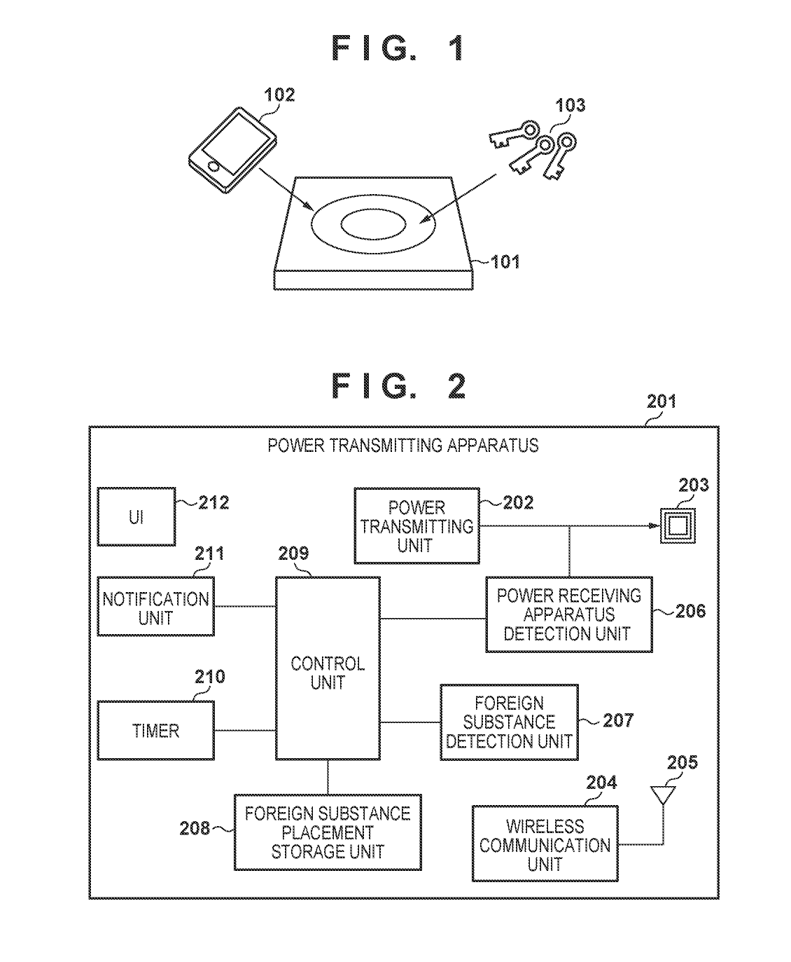

FIG. 1 is a perspective view showing the arrangement of a power transmitting system according to an embodiment. Referring to FIG. 1, a power transmitting apparatus 101 performs contactless charging (wireless power transfer), a power receiving apparatus 102 is, for example, a smartphone which operates on a battery, and a foreign substance 103 made of a metal is, for example, a key. In the following description, any object such as a conductor which does not comply with the wireless power transfer scheme and can influence power transmission will be referred to as a foreign substance.

FIG. 2 is a block diagram showing the arrangement of the power transmitting apparatus 101. Referring to FIG. 2, this arrangement includes a power transmitting apparatus body 201, a power transmitting unit 202 which generates an alternate current output, and a power transmission antenna 203 which wirelessly transmits power. Although this embodiment has exemplified a case in which contactless power transfer is performed based on the Qi standard, the power transmission scheme to be used is not limited to this.

A wireless notification unit 204 has a function necessary for wireless communication. This embodiment will exemplify the wireless notification unit 204 which performs wireless communication complying with Bluetooth® LE (Low Energy). However, the communication scheme to be used is not limited to this. An antenna 205 is used for wireless communication.

A power receiving apparatus detection unit 206 detects that the power receiving apparatus 102 is placed at the power transmission position (for example, above the antenna 205) of the power transmitting apparatus body 201. A foreign substance detection unit 207 detects that a foreign substance different from the power receiving apparatus 102 is placed and mixed in at the power transmission position of the power transmitting apparatus body 201. In this embodiment, the power receiving apparatus detection unit 206 and the foreign substance detection unit 207 emit electromagnetic waves having predetermined patterns and detect the presence/absence of the power receiving apparatus and a foreign substance based on reflections or responses corresponding to the electromagnetic waves. However, the technique of detecting the power receiving apparatus and a foreign substance is not limited to this. For example, the power receiving apparatus or a foreign substance may be detected based on a change in the impedance of the antenna 205. Alternatively, considering that irradiating a conductor with electromagnetic waves will raise the temperature of the conductor, the power receiving apparatus and a foreign substance may be detected by using temperature sensors. In addition, the power receiving apparatus and a foreign substance may be detected by detecting changes in light, magnetism, acoustic wave, image, and the like using sensors.

A foreign substance placement storage unit 208 stores that the foreign substance detection unit 207 has detected a foreign substance. The foreign substance placement storage unit 208 can be constituted by a RAM (Random Access Memory), various types of storage devices (for example, a solid state drive), and the like.

A control unit 209 controls the overall power transmitting apparatus body 201. The control unit 209 is implemented by a CPU (Central Processing Unit) or the like. A timer 210 measures times required for various types of control processing. The timer 210 is implemented by a quartz oscillator or the like.

A notification unit 211 performs notification processing of various types of information concerning charging such as foreign substance detection. In this embodiment, the notification unit 211 performs notification by outputting a sound such as a buzzer sound or voice message. However, it is possible to perform notification by any scheme that allows humans to recognize notified information. For example, notification may be performed by light blinking, message display, vibration, or the like in place of or together with sound.

In principle, when a foreign substance is detected at the power transmission position, the notification unit 211 notifies that the foreign substance should be removed. Even when a foreign substance is detected at the power transmission position, if the power receiving apparatus is not detected, the notification unit 211 does not notify that the foreign substance should be removed. More specifically, when both a foreign substance and the power receiving apparatus are detected at the power transmission position, the notification unit 211 notifies that the foreign substance should be removed. Even if, therefore, the user places a foreign substance such as a metal at the power transmission position of the power transmitting apparatus, the notification unit 211 notifies nothing unless the user places the power receiving apparatus together. This can avoid cumbersomeness caused by unnecessary notification. Note that when a foreign substance is detected at the power transmission position but the power receiving apparatus is not detected, the notification unit may output a notification with the volume being controlled as compared with the output of a notification indicating that a foreign substance should be removed upon detection of both the foreign substance and the power receiving apparatus at the power transmission position.

A UI (User Interface) 212 is used to input instructions concerning various types of operations and settings from the user, and performs, for example, output of processing results obtained by the power transmitting apparatus 101. This embodiment will exemplify the UI 212 implemented by a liquid crystal display panel (LCD panel) on which a touch panel is mounted. However, the UI 212 may be implemented by another arrangement. For example, an arrangement by which the user inputs instructions may be implemented by switches, a keyboard, and the like, and an arrangement for outputting processing results obtained by the power transmitting apparatus 101 may be implemented by an LED (Light Emitting Diode) lamp and the like. In addition, this embodiment separately includes the notification unit 211 and the UI 212. However, the notification unit 211 may perform notification by display on the UI 212.

In this embodiment, each constituent element of the power transmitting apparatus 101 is implemented by a separate piece of hardware. Some of the constituent elements may be implemented by software. That is, some constituent elements of the power transmitting apparatus 101 may be implemented by making the control unit 209 control the operation of the power transmitting apparatus 101 based on computer programs.

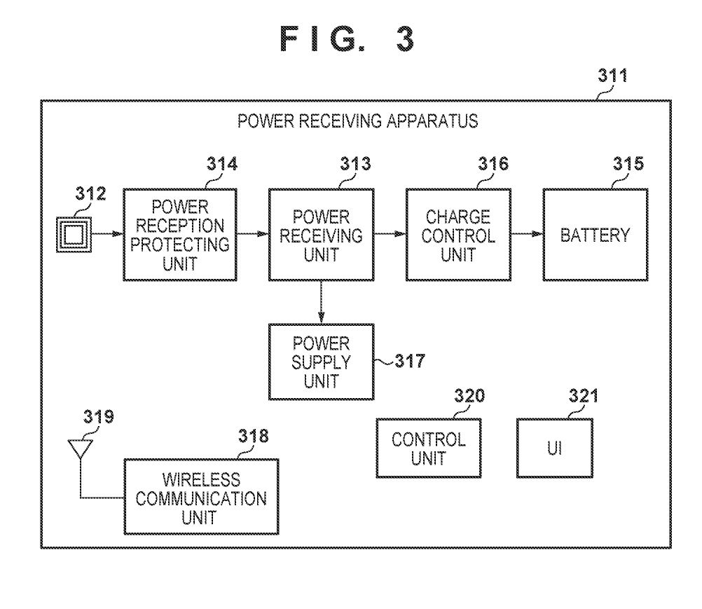

FIG. 3 is a block diagram showing the arrangement of the power receiving apparatus 102. This arrangement includes a power receiving apparatus body 311, a power receiving antenna 312 which receives power, and a power receiving unit 313 which converts a received alternate current signal into a direct current voltage by rectification. Power reception is performed by a power reception scheme corresponding to the power transmission scheme (for example, Qi) of the power transmitting apparatus 101.

A power reception protecting unit 314 protects the power receiving unit 313 while the power receiving unit 313 receives no power. The power reception protecting unit 314 electrically disconnects the power receiving antenna 312 from the power receiving unit 313 while power reception is not performed, thereby preventing damage to the power receiving unit 313 and the like due to excessive voltages and the like caused by electromagnetic waves, static electricity, and the like from the power transmitting apparatus 101. The power reception protecting unit 314 is implemented by, for example, an attenuator.

A battery 315 accumulates power received from the power transmitting apparatus 101. A charge control unit 316 performs charge control of the battery 315 by using power input from the power receiving unit 313. A power supply unit 317 switches between power input from the power receiving unit 313 and power input from the battery 315, as needed, and supplies the power to each unit of the power receiving apparatus body 311.

A wireless communication unit 318 has a function necessary for wireless communication. This embodiment will exemplify the wireless communication unit 318 which performs wireless communication complying with Bluetooth® LE. However, the communication scheme to be used is not limited to this. An antenna 319 is used for wireless communication. A control unit 320 controls the overall power receiving apparatus body 311. The control unit 320 is implemented by a CPU or the like.

A UI (User Interface) 321 is used to input instructions concerning various types of operations and settings from the user, and performs, for example, output of processing results obtained by the power receiving apparatus 102. Like the UI 212 of the power transmitting apparatus 101, the UI 321 can be implemented by a liquid crystal display panel on which a touch panel is mounted. However, the UI 321 may be implemented by another arrangement.

In this embodiment, each constituent element of the power receiving apparatus 102 is implemented by a separate piece of hardware. However, some of the constituent elements may be implemented by software. The power receiving apparatus 102 may be implemented by an information processing apparatus like a smartphone.

(Processing Procedure)

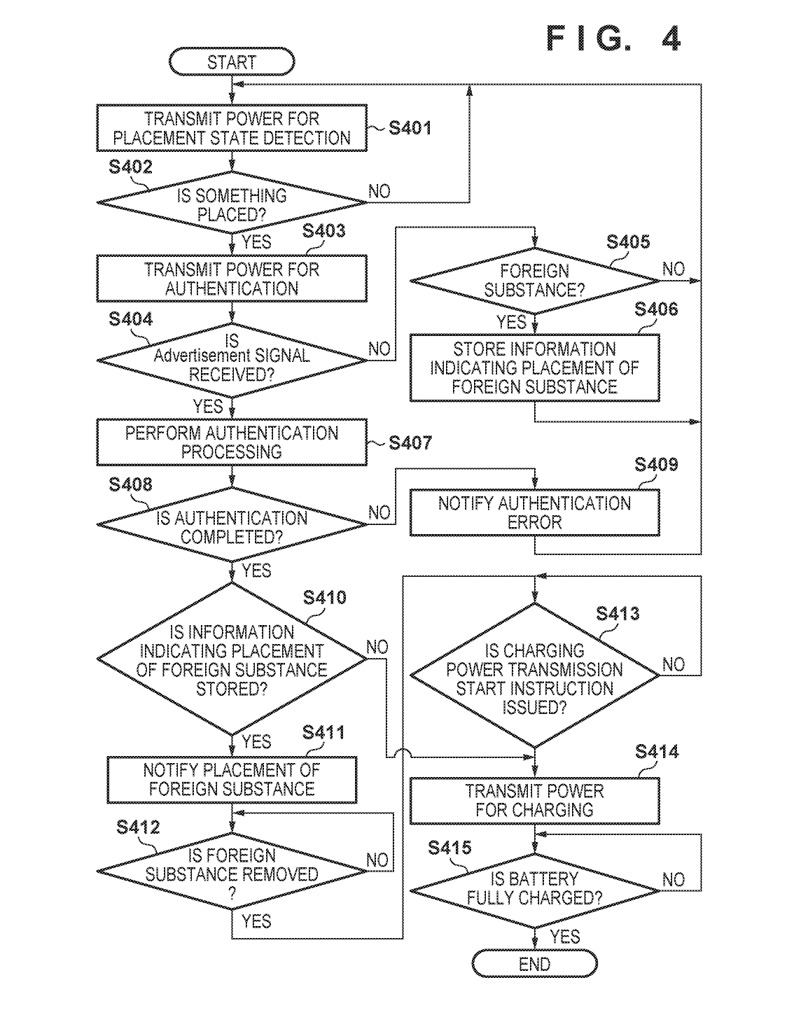

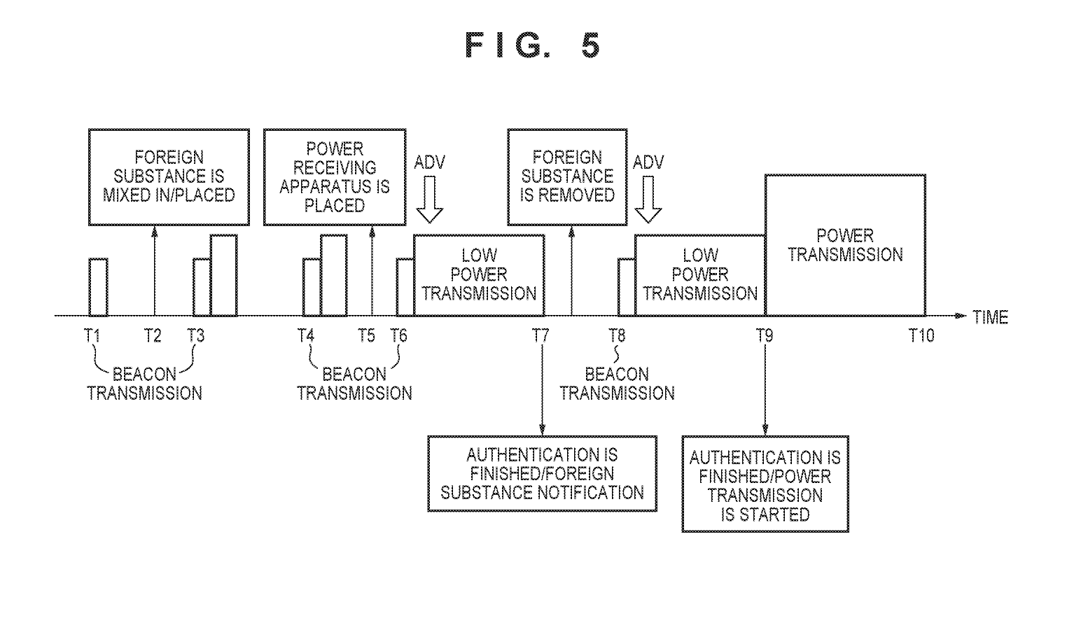

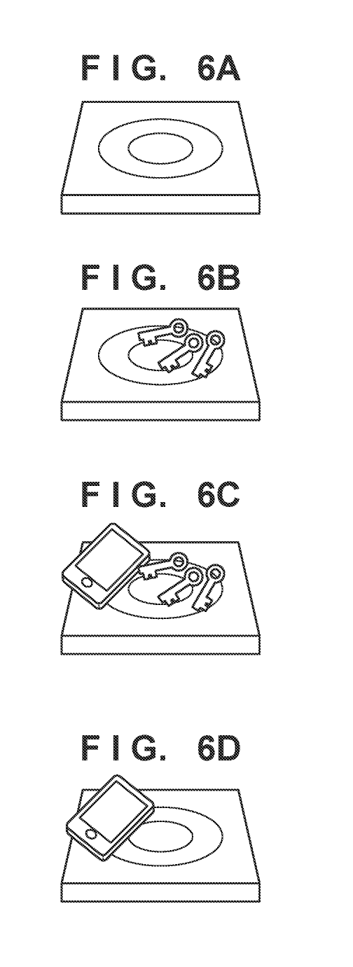

The operation of the power transmitting system according to this embodiment will be described with reference to FIGS. 4 to 6D. FIG. 4 is a flowchart showing an operation procedure of the power transmitting system according to the embodiment. FIG. 5 is a timing chart showing the operation timing of the power transmitting system according to the embodiment. FIGS. 6A, 6B, 6C, and 6D are perspective views each schematically showing a state around the power transmitting apparatus 101. Each step in FIG. 4 is executed under the control of the control unit 209 of the power transmitting apparatus 101 or the control unit 320 of the power receiving apparatus 102.

A state in which nothing is placed on the power transmitting apparatus 101 as shown in FIG. 6A will be described first. The power transmitting apparatus 101 periodically transmits a beacon signal from the power transmission antenna to detect whether something is placed on the power transmitting apparatus 101 (step S401). Referring to FIG. 5, the power transmitting apparatus 101 transmits beacon signals at times T1, T3, T4, T6, and T8.

In step S402, the power receiving apparatus detection unit 206 determines whether something is placed on the power transmitting apparatus 101 in the power transmission range of the power transmitting apparatus 101, based on detection/non-detection of a radio wave corresponding to a beacon signal. The power receiving apparatus detection unit 206 may perform determination in step S402 in accordance with an impedance value at the time of output of a beacon signal. An impedance value at the time of output of a beacon signal differs in value depending on the presence/absence of an object which receives a beacon signal in the power transmission range of the power transmitting apparatus 101. It is possible to detect an object in the power transmission range of the power transmitting apparatus 101 by using this change in impedance value. Note that the detection of an object in step S402 may be performed by another scheme such as a scheme of detecting a change in light, acoustic wave, image, or the like. If nothing is placed (NO in step S402), the process returns to step S401 to transmit a beacon signal at the next beacon signal transmission time. If something is placed (YES in step S402), the process advances to step S403.

In step S403, the power transmitting apparatus 101 transmits power for authentication at low power to start authentication processing with the power receiving apparatus 102. Note that power for authentication power transmission is a sufficient value for the activation of the control unit 320 and/or the wireless communication unit 318 of the power receiving apparatus 102. If the power receiving apparatus 102 is placed on the power transmitting apparatus 101, the power receiving apparatus 102 causes the wireless communication unit 318 to transmit an Advertisement signal (ADV) in response to the reception of this power. If an object other than the power receiving apparatus 102 is placed on the power transmitting apparatus 101, no Advertisement signal is received from the power receiving apparatus 102.

In step S404, the power transmitting apparatus 101 determines whether an Advertisement signal has been received. If the Advertisement signal has been received (YES in step S404), the process advances to step S407. If no signal has been received (NO in step S404), the process advances to step S405.

In step S405, the foreign substance detection unit 207 determines whether the object placed on the power transmitting apparatus 101 is a foreign substance. As shown in FIG. 6B, if a foreign substance is placed on the power transmitting apparatus 101 and the foreign substance detection unit 207 determines that a foreign substance is placed (YES in step S405), the process advances to step S406. If the foreign substance detection unit 207 determines that no foreign substance is placed (NO in step S405), the process returns to step S401 without performing anything. Assume that the foreign substance detection unit 207 detects the presence of an object by light, acoustic waves, or the like in step S402, and detects in step S405 that the detected object is not a conductor. In this case, the foreign substance detection unit 207 determines that the detected object is not a foreign substance (NO in step S405), and the process returns to step S401. Note that it is possible to determine that the object detected by using a beacon signal in step S402 is a foreign substance by not receiving any Advertisement signal in step S404 without performing determination in step S405. In step S406, the foreign substance placement storage unit 208 stores information indicating that the object is placed, and the process returns to step S401.

A case in which the power receiving apparatus 102 is placed on the power transmitting apparatus 101 as shown in FIG. 6C will be described next. In such a case, the power receiving apparatus 102 activates the wireless communication unit 318 in a standby state and transmits an Advertisement signal in response to when the power receiving unit 313 and the power supply unit 317 supply power to the wireless communication unit 318. Referring to FIG. 5, the power receiving apparatus 102 is placed on the power transmitting apparatus 101 at time T5, and low power transmission is started after beacon signal transmission at time T6. The power transmitting apparatus 101 then receives an Advertisement signal (ADV) (YES in step S404).

In step S407, the power transmitting apparatus 101 performs the authentication processing of authenticating the power receiving apparatus 102 by wireless communication with the power receiving apparatus 102. In step S408, the power transmitting apparatus 101 determines whether authentication is successful. If authentication is successful (YES in step S408), the process advances to step S410. If authentication is not successful (NO in step S408), the process advances to step S409. In step S409, the UI 212 of the power transmitting apparatus 101 notifies an authentication error. The process then returns to step S401.

In step S410, it is checked whether information indicating that a foreign substance is placed is recorded in the foreign substance placement storage unit 208 (step S410). If there is information indicating that a foreign substance is placed (YES in step S410), the notification unit 211 notifies that a foreign substance is placed in step S411. Referring to FIG. 5, authentication is completed at time T7, and foreign substance notification is performed. Note that the UI 212 may perform notification. When the notification of the foreign substance is completed, the process advances to step S412. If there is no information indicating that a foreign substance is placed (NO in step S410), the process advances to step S414.

In step S412, the foreign substance detection unit 207 determines whether the foreign substance has been removed. If the foreign substance detection unit 207 determines that the foreign substance has been removed (YES in step S412), the process advances to step S413. If the foreign substance detection unit 207 determines that the foreign substance has not been removed (NO in step S412), the power transmitting apparatus stands by until it is determined that the foreign substance has been removed. If the foreign substance has been removed from the power transmitting apparatus 101 as shown in, for example, FIG. 6D (YES in step S412), only the power receiving apparatus 102 is placed on the power transmitting apparatus 101. The process then advances to step S413.

In step S413, it is determined whether a power transmission start instruction to charge the battery of the power receiving apparatus 102 is input. If it is determined that such an instruction is input (YES in step S413), the process advances to step S414. If it is determined that such an instruction is not input (NO in step S413), the power transmitting apparatus stands by until such an instruction is input. In this embodiment, whether a power transmission start instruction is input is determined by determining whether a power transmission instruction is issued to the UI 212 of the power transmitting apparatus 101. However, the determination technique to be used is not limited to this. For example, the above determination may be performed by determining whether a power transmission instruction is issued to the UI 321 of the power receiving apparatus 102. If the UI 212 has operated to input a power transmission start instruction for battery charging (step S413), the process advances to step S414.

In step S414, the power transmitting apparatus 101 starts power transmission for charging with respect to the power receiving apparatus 102. Note that power transmission for charging in step S414 is performed with power higher than a beacon signal and power transmission for authentication (low power transmission). In step S415, it is determined whether the battery 315 of the power receiving apparatus 102 is fully charged. If the battery is fully charged (YES in step S415), power transmission is finished. If the battery is not fully charged (NO in step S415), power transmission is continued. Note that if a foreign substance is detected while power transmission for charging is performed in step S414, power transmission is stopped. The power transmitting apparatus 101 stores information indicating the detection of a foreign substance and performs processing from step S411.

Referring to FIG. 5, the power transmitting apparatus 101 finishes authentication again at time T9 (step S407), and starts power transmission (step S414). Note that in this case, the power receiving apparatus 102 may notify the power transmitting apparatus 101 of the remaining battery capacity of the power receiving apparatus 102 by wireless communication before power transmission. In this case, if the remaining battery capacity is equal to or larger than a predetermined value, the power transmitting apparatus 101 may not perform notification of a foreign substance or power transmission. If, for example, the battery is full or filled to 99% or more of the battery capacity, the power transmitting apparatus 101 may perform neither notification of a foreign substance nor power transmission. Alternatively, if the remaining battery capacity is equal to or larger than a predetermined value near full charge, for example, equal to or larger than 99% of the battery capacity, the power transmitting apparatus 101 may not perform notification of a foreign substance but may transmit power.

When transmitting a beacon after the placement of a foreign substance, the power transmitting apparatus 101 may transmit the beacon at a level higher than a normal transmission level by a predetermined value. FIG. 5 shows a case in which the transmission level at the time of beacon transmission is increased after time T3. Increasing the transmission level of a beacon to a level higher than the normal level can reduce the influence of a foreign substance when detecting the placement of the power receiving apparatus 102. Assume that before the power transmitting apparatus 101 notifies the detection of a foreign substance when the power receiving apparatus 102 is placed after the foreign substance is placed, another foreign substance is further placed. In this case, the power transmitting apparatus 101 may exceptionally notify the detection of the foreign substance before the power receiving apparatus 102 is placed.

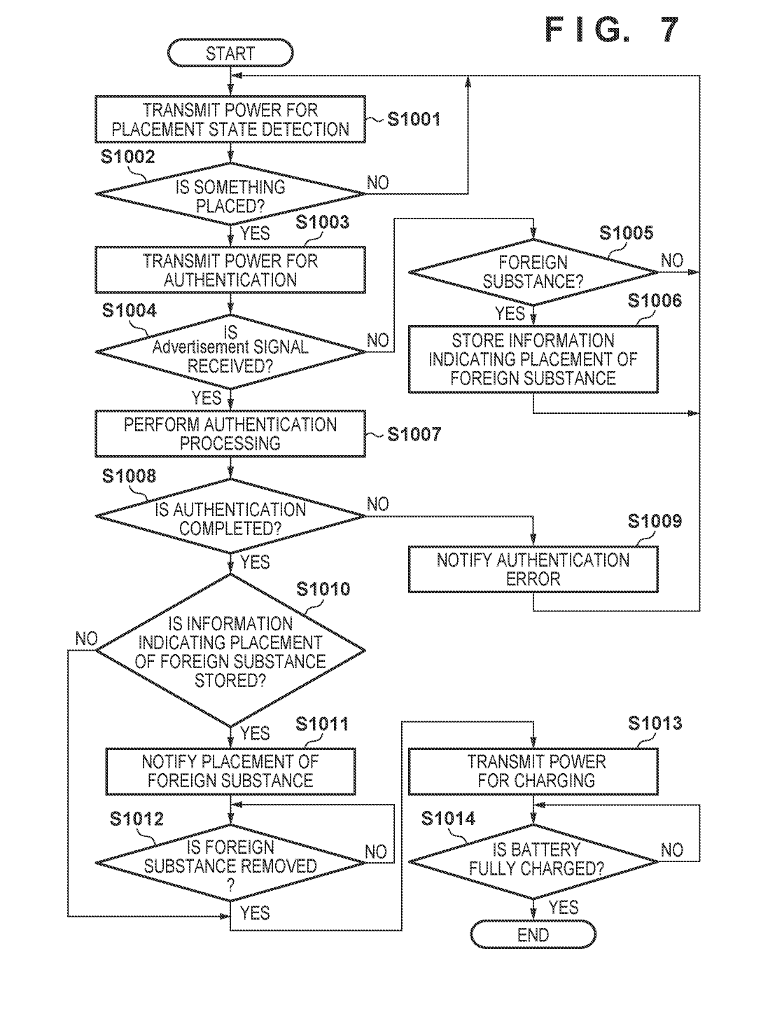

Note that the power transmitting apparatus may automatically start power transmission when the foreign substance detection unit 207 determines the removal of a foreign substance instead of starting power transmission in response to a request to start power transmission from the user upon operation with the UI 212 in step S413. That is, when only the power receiving apparatus 102 is placed on the power transmitting apparatus 101, the power transmitting apparatus 101 may always transmit power without performing determination in step S413. FIG. 7 shows a flowchart for this case. The flowchart of FIG. 7 shows the same operation as that shown in FIG. 4 except that step S413 in FIG. 4 is omitted.

As described above, in this embodiment, even if a foreign substance is placed or mixed in before the power receiving apparatus is placed on the power transmitting apparatus, the power transmitting apparatus does not notify the detection of the foreign substance, and notifies the detection of the foreign substance when the power receiving apparatus is placed. As described above, even if only a foreign substance is placed near the power transmitting apparatus, the power transmitting apparatus does not notify the detection of the foreign substance. Therefore, when the power transmitting apparatus is mounted in a piece of furniture or vehicle, it is possible to avoid cumbersomeness caused by unnecessary notification and can also notify the detection of a foreign substance if necessary.

Although this embodiment has exemplified the case in which when a foreign substance and the power receiving apparatus are placed on the power transmitting apparatus, the apparatus transmits power after the foreign substance is removed, the apparatus may start power transmission before the foreign substance is removed. For example, the power transmitting apparatus may be configured to always continue power transmission during its activation. Even in such a case, it is possible to avoid cumbersomeness caused by unnecessary notification by not notifying information indicating that a foreign substance should be removed, when the power receiving apparatus is not detected even if a foreign substance is detected at the power transmission position.

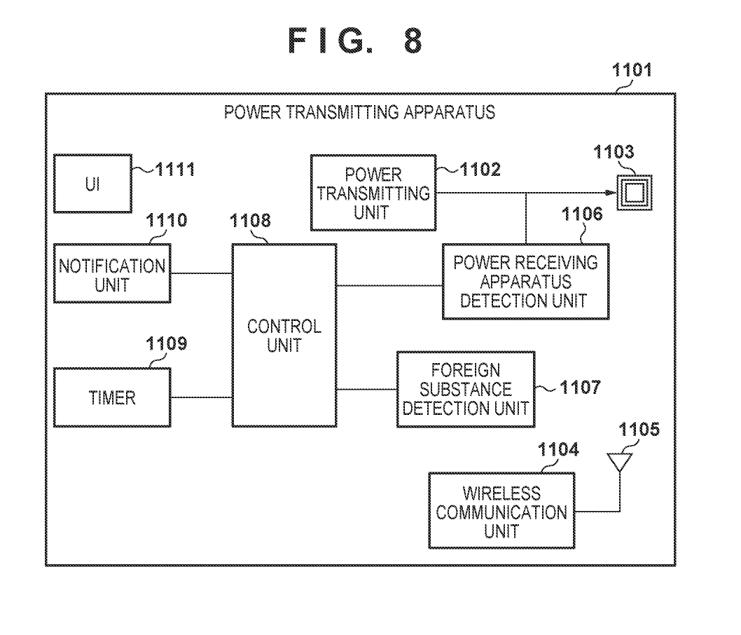

The above embodiment has exemplified the case in which upon detecting a foreign substance, the power transmitting apparatus 101 records corresponding information in the foreign substance placement storage unit 208, and determines whether a foreign substance is placed on it, by referring to the foreign substance placement storage unit 208 upon completion of authentication with the power receiving apparatus. Another embodiment will exemplify an arrangement configured to determine whether a foreign substance is placed when transmitting power, without providing the foreign substance placement storage unit 208, as shown in FIG. 8.

FIG. 9 is a flowchart showing an operation procedure of a power transmitting system according to this embodiment. Operations in steps S1201 to S1207 and S1209 to S1212 in FIG. 9 are the same as those in steps S401 to S404, S407 to S409, S411, S412, S414, and S415 in FIG. 4 which are referred to in the above embodiment. In this embodiment, after authentication is completed in step S1205 and authentication processing is finished (YES in step S1206), a foreign substance detection unit 207 determines whether a foreign substance is placed on the power transmitting apparatus (step S1208). If it is determined that a foreign substance is placed on the power transmitting apparatus (YES in step S1208), the apparatus notifies the detection of the foreign substance in step S1209. If it is determined that no foreign substance is placed on the apparatus (NO in step S1208), the apparatus starts power transmission in step S1211.

In this manner, in this embodiment, when starting power transmission upon completion of authentication with a power receiving apparatus 102, the foreign substance detection unit 207 detects the presence/absence of a foreign substance. If it is determined that a foreign substance is present, the presence of the foreign substance is notified. It is therefore possible to prevent unnecessary notification when only a foreign substance is placed on a power transmitting apparatus 101, and to notify the detection of a foreign substance upon detection of the foreign substance at the time of power transmission to the power receiving apparatus to prompt the user to prevent a reduction in power transmission efficiency by removing the foreign substance.

The above embodiment has exemplified the case in which the power receiving apparatus detection unit 206 detects the placement of the power receiving apparatus on the power transmitting apparatus, and the foreign substance detection unit 207 detects the placement of a foreign substance. However, it is not always necessary to provide the dedicated power receiving apparatus detection unit 206 and foreign substance detection unit 207. Similar functions may be implemented by other arrangements.

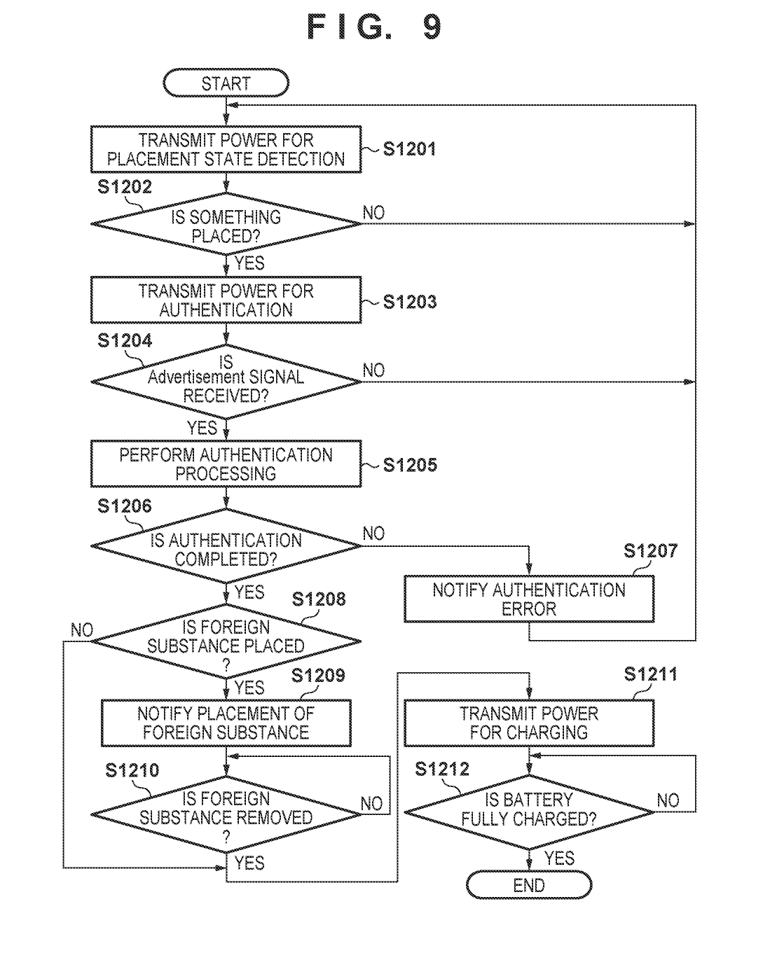

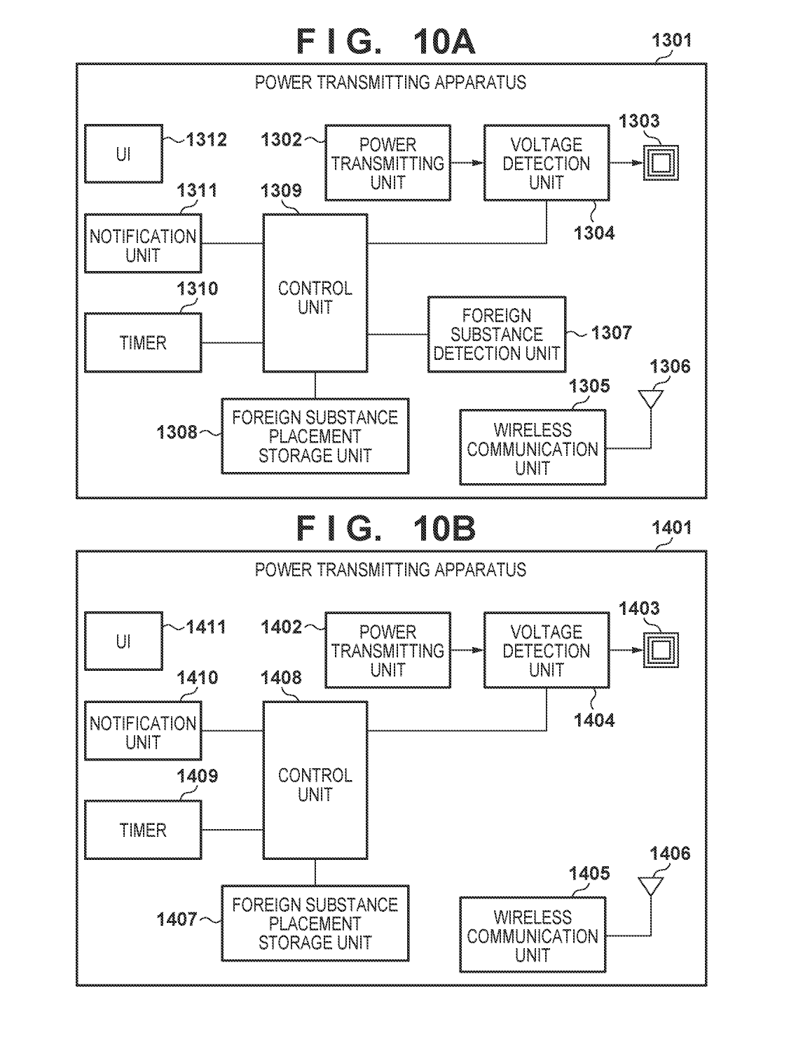

FIG. 10A shows a case in which a voltage detection unit 1304 is provided between a power transmitting unit 1302 and a power transmission antenna 1303 without providing a power receiving apparatus detection unit. Referring to FIG. 10A, the voltage detection unit 1304 detects a power transmission voltage from the power transmitting unit 1302 and the voltage of radio waves reflected and returned from the power transmission antenna. The placement of the power receiving apparatus is then detected based on the voltage detected when the power receiving apparatus is placed on the power transmitting apparatus.

FIG. 10B shows a case in which the voltage detection unit 1304 is provided between a power transmitting unit 1402 and an antenna 1403 without providing a power receiving apparatus detection unit and a foreign substance detection unit. Referring to FIG. 10B, the voltage detection unit 1304 detects a power transmission voltage from the power transmitting unit 1302 and a voltage reflected and returned from the power transmission antenna. The placement of a power receiving apparatus and a foreign substance is then detected based on the detection value of a voltage when the power receiving apparatus and the foreign substance are placed on the power transmitting apparatus.

As described above, this embodiment is configured to detect the power receiving apparatus and a foreign substance based on the voltages of power reflected and returned in accordance with power transmission voltages and transmitted power upon experimental power transmission. Only when both the power receiving apparatus and a foreign substance are detected, notification is performed to prompt to remove the foreign substance. This makes it possible to perform notification only when it is necessary to remove a foreign substance, while preventing unnecessary notification.

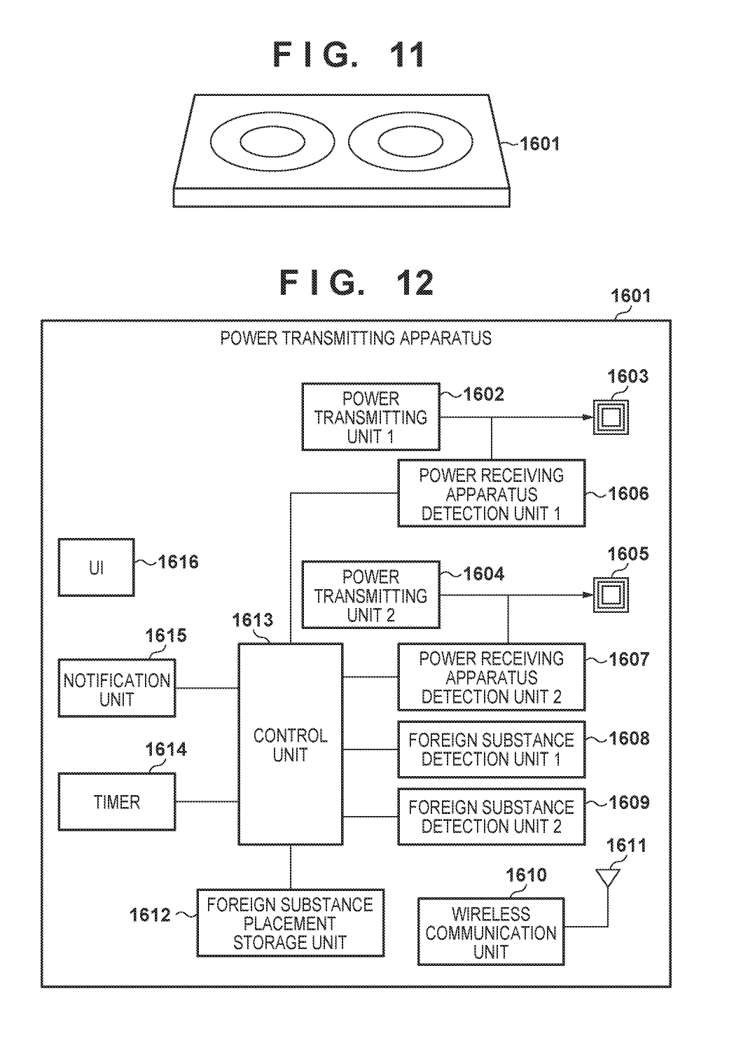

The arrangement and operation of a power transmitting apparatus incorporating a plurality of power transmission antennas will be described next. FIG. 11 shows a power transmitting apparatus 1601 incorporating two power transmission antennas. FIG. 12 is a block diagram showing the arrangement of the power transmitting apparatus 1601.

Referring to FIG. 12, the power transmitting apparatus body 1601 includes first power transmitting unit 1 (to be referred to as a “first power transmitting unit 1602” hereinafter) which generates an alternate current output, first power transmission antenna 1 (to be referred to as a “first power transmission antenna 1603” hereinafter) which transmits power, second power transmitting unit 2 (to be referred to as a “second power transmitting unit 1604” hereinafter) which generates an alternate current output, and second power transmission antenna 2 (to be referred to as a “second power transmission antenna 1605” hereinafter) which transmits power.

First power receiving apparatus detection unit 1 (to be referred to as a “first power receiving apparatus detection unit 1606” hereinafter) detects the placement of the power receiving apparatus on the power transmitting apparatus body 1601. Second power receiving apparatus detection unit 2 (to be referred to as a “second power receiving apparatus detection unit 1607” hereinafter) detects the placement of the power receiving apparatus on the power transmitting apparatus body 1601. First foreign substance detection unit 1 (to be referred to as a “first foreign substance detection unit 1608” hereinafter) detects that a foreign substance different from the power receiving apparatus is placed and mixed in on the power transmitting apparatus body 1601. Second foreign substance detection unit 2 (to be referred to as a “second foreign substance detection unit 1609” hereinafter) detects that a foreign substance different from the power receiving apparatus is placed and mixed in on the power transmitting apparatus body 1601. A wireless communication unit 1610 has a function necessary for wireless communication. An antenna 1611 is used for wireless communication. A foreign substance placement storage unit 1612 stores information indicating that the first foreign substance detection unit 1608 and the second foreign substance detection unit 1609 have detected foreign substances.

A control unit 1613 controls the overall power transmitting apparatus body 1601. A timer 1614 measures times required for various types of control processing. A notification unit 1615 performs notification processing of various types of information concerning charging. A UI (User Interface) 1616 is used to perform various types of input operations, display operation, and the like.

The power transmitting apparatus body 1601 in FIG. 12 differs from the power transmitting apparatus body 201 in FIG. 4 in that it includes two each of the power transmitting unit, power transmission antenna, power receiving apparatus detection unit, and foreign substance detection unit. The first and second power transmitting units, first and second power transmission antennas, first and second power receiving apparatus detection units, and first and second foreign substance detection units of the power transmitting apparatus body 1601 each have a function similar to that of the power transmitting apparatus body 201. In addition, the wireless communication unit 1610, the antenna 1611, the foreign substance placement storage unit 1612, the control unit 1613, the timer 1614, the notification unit 1615, and the UI 1616 of the power transmitting apparatus body 1601 each have a function similar to that of the power transmitting apparatus body 201.

In this embodiment, the first power transmitting unit, the first power transmission antenna, the first power receiving apparatus detection unit, and the first foreign substance detection unit each and the second power transmitting unit, the second power transmission antenna, the second power receiving apparatus detection unit, and the second foreign substance detection unit each independently operate in the same manner as in the arrangement of the embodiment described above. That is, only when both the power receiving apparatus and a foreign substance are placed on one of the first power transmission antenna 1603 and the second power transmission antenna 1605, the placement of a foreign substance is notified; otherwise, the placement of a foreign substance is not notified. A state in which nothing is placed on the power transmitting apparatus body 1601 as shown in FIG. 11 will be described first.

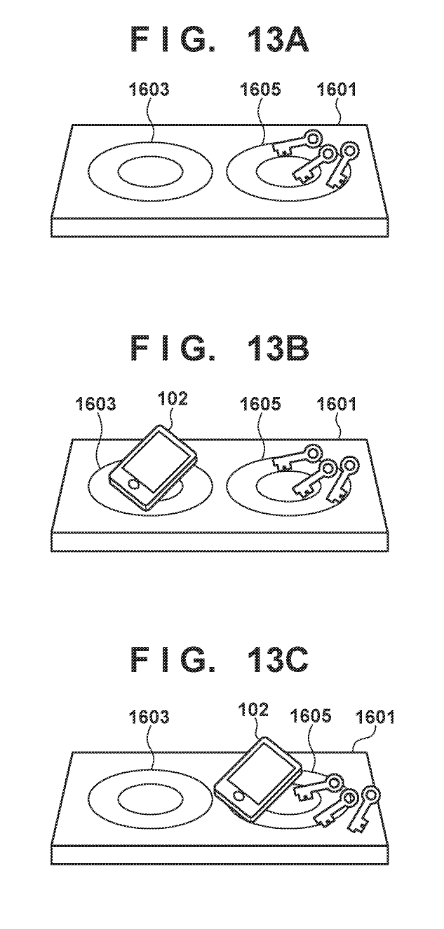

As shown in FIG. 13A, even if a foreign substance is placed on the second power transmission antenna 1605 of the power transmitting apparatus body 1601, the placement of the foreign substance is not notified as described in the above embodiment.

When the power receiving apparatus 102 is placed on the first power transmission antenna 1603 in addition to the placement of a foreign substance on the second power transmission antenna 1605 as shown in FIG. 13B, the first power receiving apparatus detection unit 1606 detects the placement of the power receiving apparatus 102. In this case, the foreign substance is placed on the second power transmission antenna 1605, and has no influence on power transmission to the power receiving apparatus 102. For this reason, as described in the above embodiment, power transmission is started after the completion of authentication with the power receiving apparatus 102.

Assume that the power receiving apparatus 102 is placed on the second power transmission antenna 1605 in addition to the placement of a foreign substance on the second power transmission antenna 1605, as shown in FIG. 13C. In this case, the second foreign substance detection unit 1609 detects the foreign substance, and notifies the placement of the foreign substance, as described in the above embodiment. After the foreign substance is removed, authentication processing with the power receiving apparatus 102 is performed again. After the completion of the authentication, power transmission is started.

As described above, the arrangement according to this embodiment includes a plurality of power transmission antennas. Each power transmission antenna detects the presence/absence of the power receiving apparatus and a foreign substance. When both the power receiving apparatus and a foreign substance are placed on the same power transmission antenna, the placement of the foreign substance is notified. This makes it possible to prevent unnecessary notification while notifying the placement of a foreign substance only when it has an influence on the power transmission efficiency.

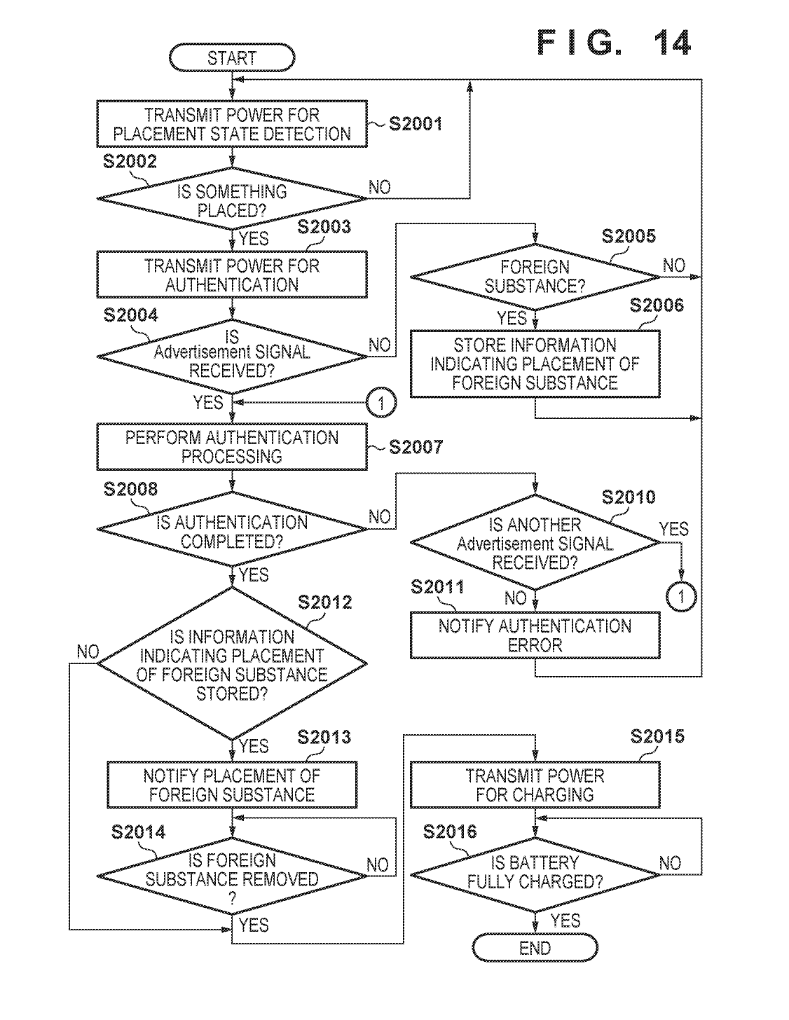

The above embodiment has exemplified the case in which the power receiving apparatus complies with the power transmission specifications (the standard version, power transmission power value, and the like) of the power transmitting apparatus. This embodiment will exemplify, with reference to FIGS. 14 to 16B, an operation to be performed when a power receiving apparatus which does not comply with the power transmission specifications of the power transmitting apparatus is placed on it.

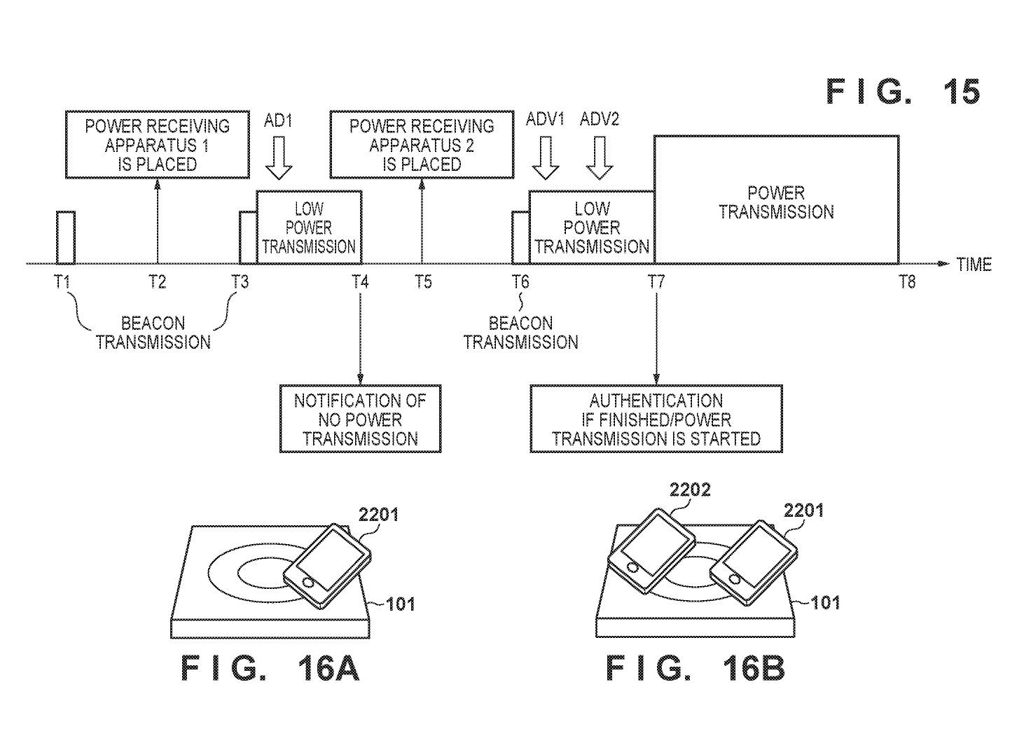

FIG. 14 is a flowchart showing an operation procedure of the power transmitting system according to this embodiment. FIG. 15 is a timing chart showing the operation timing of the power transmitting system according to this embodiment. FIGS. 16A and 16B are perspective views each schematically showing a state around the power transmitting apparatus 101.

A state in which nothing is placed on the power transmitting apparatus 101 as shown in FIG. 6A will be described first. The power transmitting apparatus 101 periodically transmits a beacon signal from the power transmission antenna to detect whether something is placed on the power transmitting apparatus (step S2001).

Referring to FIG. 15, the power transmitting apparatus 101 transmits beacon signals for detecting the placement of something on the power transmitting apparatus at times T1, T3, and T6. The power transmitting apparatus 101 causes the power receiving apparatus detection unit 206 to detect, based on beacon signals, whether something is placed on the power transmitting apparatus (step S2002). If nothing is placed (NO in step S2002), the process returns to step S2001. If something is placed (YES in step S2002), the power transmitting apparatus 101 transmits power at low power to start authentication processing with the power receiving apparatus (step S2003).

The power transmitting apparatus then determines whether an Advertisement signal corresponding to the power transmission for authentication has been received (step S2004). If the signal has been received (YES in step S2004), the process advances to step S2007. If the signal has not been received (NO in step S2004), the process advances to step S2005. If, for example, an object other than the power receiving apparatus is placed on the power transmitting apparatus, the apparatus does not receive any Advertisement signal from the power receiving apparatus (NO in step S2004).

In step S2005, it is determined whether a foreign substance is placed on the power transmitting apparatus 101. If a foreign substance is placed (YES in step S2005), the process advances to step S2006. If no foreign substance is placed (NO in step S2005), the process returns to step S2001. If a foreign substance is placed on the power transmitting apparatus 101 and is determined as a foreign substance by the foreign substance detection unit 207 as shown in FIG. 6B (YES in step S2005), the process advances to step S2006. In step S2006, as in the above embodiment, information indicating the placement of the foreign substance is stored in the foreign substance placement storage unit 1612, and the process return to step S2001.

When a power receiving apparatus 2201 is placed as shown in FIG. 16A, the power receiving apparatus 2201 causes a power receiving unit 313 and a power supply unit 317 to supply power to a wireless communication unit 318, as described in the above embodiment. In response to this power supply, the wireless communication unit 318 in a standby state is activated to transmit an Advertisement signal. Referring to FIG. 15, the power receiving apparatus is placed at time T2, and low power transmission is started after the transmission of a beacon at time T3. The power transmitting apparatus then receives an Advertisement signal (ADV) (YES in step S2004). The process then advances to step S2007.

In step S2007, the power transmitting apparatus 101 performs the authentication processing of authenticating the power receiving apparatus 102 by wireless communication with the power receiving apparatus 102. In step S2008, the power transmitting apparatus 101 determines whether authentication is completed. If the authentication is completed (YES in step S2008), the process advances to step S2012. If the authentication is not completed (NO in step S2008), the process advances to step S2010. In the above case, since the power receiving apparatus 2201 does not comply with the power transmission specifications of the power transmitting apparatus 101, the authentication is not completed. The process therefore advances to step S2010.

In step S2010, the power transmitting apparatus 101 determines whether it has received an Advertisement signal (ADV) from another power receiving apparatus. If the apparatus has received the signal (YES in step S2010), the process returns to step S2007. If the apparatus has not received the signal (NO in step S2010), the process advances to step S2011.

In step S2011, a UI 212 notifies that since the power receiving apparatus 102 does not comply with the specifications of the power transmitting apparatus 101, the apparatus does not transmit power. The process then returns to step S2001. Referring to FIG. 15, in this case, the power transmitting apparatus 101 finishes the authentication processing at time T4, and notifies that power is not transmitted because the authentication is not completed.

An operation to be performed when a second power receiving apparatus 2202 complying with the power transmission specifications of the power transmitting apparatus is placed as shown in FIG. 16B will be described next. In this case, in step S2010, the power transmitting apparatus receives an Advertisement signal (ADV) from another power receiving apparatus. The power transmitting apparatus then performs authentication processing with the second power receiving apparatus 2202 (step S2007) and determines whether the authentication is completed (step S2008). If the authentication is completed, the process advances to step S2012. If the authentication is not completed, the process advances to step S2010.

If the authentication is completed (YES in step S2008), the same operation as that described in the above embodiment is performed, and power transmitted until the battery is fully charged (steps S2015 and S2016).

Referring to FIG. 15, in this case, the power transmitting apparatus completes the authentication at time T7 and starts power transmission. The power receiving apparatus 2201 causes a power reception protecting unit 314 to perform a shutoff operation so as not to transmit received power to the power receiving unit 313. Since the power receiving apparatus 2201 does not comply with the specifications of the power transmitting apparatus 101, the power transmitting apparatus 101 does not notify the power receiving apparatus 2201 that no power is transmitted.

As described above, in this embodiment, when a power receiving apparatus at the power transmission position does not comply with the power transmission scheme of the power transmission antenna and authentication is not completed, as well as when a foreign substance is detected, the power transmitting apparatus notifies corresponding information. This allows the power transmitting apparatus 101 to perform proper notification in accordance with the specifications of a power receiving apparatus placed on the power transmitting apparatus 101.

As described above, in each embodiment, when only a foreign substance is placed on the power transmission antenna of the power transmitting apparatus which performs wireless power transfer to the power receiving apparatus, the power transmitting apparatus does not notify the user of an error. When both a foreign substance and the power receiving apparatus are placed on the power transmission antenna, the power transmitting apparatus notifies the user of an error. This inhibits the power transmitting apparatus from always notifying the user of an error every time he/she places a metal object such as a key on the power transmitting apparatus, and hence can improve the convenience of the user.

In addition, when a foreign substance is detected, the power transmitting apparatus does not transmit power for charging the power receiving apparatus until determining the removal of the foreign substance, and starts power transmission in response to the removal of the foreign substance. This makes it possible to reliably start contactless charging of the power receiving apparatus after the removal of the foreign substance. In addition, when both a foreign substance and the power receiving apparatus are detected, an error is notified for only a duration until the start of charging. The user can therefore receive a notification only when necessary.

The present invention can provide a technique of reducing unnecessary notification concerning foreign substance detection when something other than a power receiving apparatus exists in the power transmission range of a power transmitting apparatus.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-190339, filed on Sep. 28, 2015, which is hereby incorporated by reference herein in its entirety.

What is claimed is:

1. A power transmitting apparatus which performs wireless power transfer to a power receiving apparatus, the apparatus comprising:
a power transmitting unit adapted to wirelessly transmit power;
a first detection unit adapted to detect a foreign substance as an object different from a power receiving apparatus in a power transmission range of a power transmitting unit;
a second detection unit adapted to detect a power receiving apparatus in the power transmission range; and
a control unit adapted to output a predetermined notification concerning an error when the first detection unit detects the foreign substance and the second detection unit detects a power receiving apparatus and to limit output of the predetermined notification when the first detection unit detects the foreign substance and the second detection unit does not detect a power receiving apparatus.

2. The apparatus according to claim 1, wherein when both a foreign substance and a power receiving apparatus are detected in the power transmission range, the control unit outputs a notification indicating that the foreign substance should be removed.

3. The apparatus according to claim 2, wherein when both a foreign substance and a power receiving apparatus are detected in the power transmission range, the control unit outputs a notification indicating that the foreign substance should be removed for a duration until start of power transmission for charging the power receiving apparatus.

4. The apparatus according to claim 2, wherein
the power transmitting unit comprises a plurality of the power transmitting units, and
when both a foreign substance and a power receiving apparatus are detected in the power transmission range of the same power transmitting unit, the control unit outputs a notification indicating that the foreign substance should be removed.

5. The apparatus according to claim 1, further comprising a storage unit adapted to store information indicating that a foreign substance is detected, when the first detection unit detects the foreign substance,
wherein the control unit outputs a notification indicating that a foreign substance should be removed, when the storage unit stores the information.

6. The apparatus according to claim 1, wherein the power transmitting unit transmits power when a power receiving apparatus is detected and no foreign substance is detected in the power transmission range.

7. The apparatus according to claim 6, wherein when both a foreign substance and a power receiving apparatus are detected in the power transmission range, the power transmitting unit does not transmit power until the foreign substance is removed from the power transmission range.

8. The apparatus according to claim 7, wherein when both a foreign substance and a power receiving apparatus are detected in the power transmission range, the power transmitting unit starts power transmission in response to a power transmission start request from a user after removal of the foreign substance from the power transmission range.

9. The apparatus according to claim 1, further comprising an authentication unit adapted to perform authentication processing with the power receiving apparatus in accordance with detection of a power receiving apparatus in the power transmission range,
wherein when the authentication processing is not successful, the control unit outputs a notification that the authentication processing is not successful.

10. The apparatus according to claim 9, wherein the authentication unit authenticates whether a power receiving apparatus in the power transmission range complies with a power transmission scheme of the power transmitting unit.

11. The apparatus according to claim 1, further comprising a third detection unit adapted to detect a voltage of a radio wave generated when an experimental radio wave generated from the power transmitting unit is reflected,
wherein the second detection unit detects a power receiving apparatus based on the voltage.

12. The apparatus according to claim 1, further comprising a third detection unit adapted to detect a voltage of a radio wave generated when an experimental radio wave generated from the power transmitting unit is reflected,
wherein the first detection unit detects a foreign substance based on the voltage.

13. The apparatus according to claim 1, wherein the control unit outputs a notification indicating that a foreign substance should be removed to a power receiving apparatus by wireless communication.

14. A control apparatus for a power transmitting apparatus including a power transmitting unit adapted to wirelessly transmit power, a first detection unit adapted to detect a foreign substance as an object different from a power receiving apparatus in a power transmission range of the power transmitting unit, and a second detection unit adapted to detect a power receiving apparatus in the power transmission range, the apparatus comprising
a control unit adapted to perform a predetermined notification, when the first detection unit detects the foreign substance and the second detection unit detects a power receiving apparatus, and
not to perform the predetermined notification when the first detection unit detects the foreign substance and the second detection unit does not detect a power receiving apparatus.

15. A method of controlling a power transmitting apparatus which wirelessly transmits power, the method comprising:
detecting presence/absence of a foreign substance as an object different from a power receiving apparatus in a power transmission range of the power transmitting apparatus;
detecting presence/absence of a power receiving apparatus in the power transmission range;
outputting a predetermined notification when the foreign substance is detected and a power receiving apparatus is detected; and
limiting output of the predetermined notification when the foreign substance is detected in the detecting the presence/absence of the foreign substance and a power receiving apparatus is not detected.

16. A non-transitory computer-readable storage medium storing a computer program for causing a computer to function as each unit of a power transmitting apparatus which performs wireless power transfer to a power receiving apparatus, the power transmitting apparatus comprising:
a power transmitting unit adapted to wirelessly transmit power;
a first detection unit adapted to detect a foreign substance as an object different from a power receiving apparatus in a power transmission range of the power transmitting unit;
a second detection unit adapted to detect a power receiving apparatus in the power transmission range; and
a control unit adapted to output a predetermined notification concerning an error when the first detection unit detects the foreign substance and the second detection unit detects a power receiving apparatus and to limit output of the predetermined notification when the first detection unit detects the foreign substance and the second detection unit does not detect a power receiving apparatus.
